(19) United States
(12) Patent Application Publication
(10) Pub. No.: US 2025/0312689 A1
(43) Pub. Date: Oct. 9, 2025

(54) PRIZE ACQUISITION GAME DEVICE

(71) Applicant: SEGA CORPORATION, Tokyo (JP)

(72) Inventors: Riho Takikawa, Tokyo (JP); Mitsuharu Fukazawa, Tokyo (JP); Takaya Goshozono, Tokyo (JP); Yuuki Hanafusa, Tokyo (JP); Momoko Fukunaga, Tokyo (JP)

(73) Assignee: SEGA CORPORATION, Tokyo (JP)

(21) Appl. No.: 19/242,290

(22) Filed: Jun. 18, 2025

Related U.S. Application Data
(63) Continuation of application No. PCT/JP2023/038108, filed on Oct. 20, 2023.

(30) Foreign Application Priority Data
Jan. 23, 2023 (JP) 2023-008308

(51) Int. Cl. A63F 9/30; G07F 17/32

(52) U.S. Cl. CPC A63F 9/30; G07F 17/3297; A63F 2250/144

(57) ABSTRACT

The prize acquisition game device includes: a crane configured to acquire a prize; a housing having a housing space in which a prize is disposed on an exhibition part including: a first prize placement plate that defines an opening area; and a second prize placement plate that covers a portion of the opening area and defines a drop port area; and a support that supports the second prize placement plate to be switchable between a straight arrangement and a diagonal arrangement. In the straight arrangement, the second prize placement is shifted from the first prize placement plate in an orthogonal direction orthogonal to a front-back direction or a left-right direction of the housing. In the diagonal arrangement, the second prize placement is shifted from the first prize placement plate in a diagonal direction intersecting the front-back direction or the left-right direction.

### BACKGROUND

### Technical Field

The present invention relates to a prize acquisition game device.

### Description of Related Art

There are known prize acquisition game devices that cause a player to play a game to obtain a prize housed in a housing space for the prize (for example, Patent Document 1).

### PATENT DOCUMENTS

Patent Document 1: JP 2019-98076 A

### Technological Problem to Be Solved by Invention

The prize acquisition game device described in Patent Document 1 displays prizes within a housing space by placing them on a prize placement plate. Then, by rearranging the prize placement plate, it is possible to change the position, shape, and size of the drop port area through which the prizes are dropped. However, although the orientation of the prize placement plate can be changed in 90 degree increments, it is difficult to dispose the prize placement plate diagonally by shifting the orientation diagonally.

### SUMMARY

One or more embodiments of the present invention enable the prize placement plate to be disposed diagonally.

In one aspect of the present invention, a prize acquisition game device comprises: a housing having a housing space in which a prize is disposed on an exhibition part; a crane configured to acquire the prize; the exhibition part comprises: a first prize placement plate that defines an opening area in the housing space; and a second prize placement plate that covers a portion of the opening area and defines a drop port area in which the prize may drop; and a support that supports the second prize placement plate to be switchable between a straight arrangement and a diagonal arrangement with respect to the first prize placement plate, wherein in the straight arrangement, the second prize placement is shifted from the first prize placement plate in an orthogonal direction orthogonal to a front-back direction or a left-right direction of the housing, and in the diagonal arrangement, the second prize placement is shifted from the first prize placement plate in a diagonal direction intersecting the front-back direction or the left-right direction.

Other features of the present invention will become apparent from the following detailed description of the present invention and the accompanying drawings.

### BRIEF DESCRIPTION OF DRAWINGS

FIG. 1 is an external view illustrating a configuration of a prize acquisition game device 1 according to one or more embodiments.

FIG. 2 is a schematic perspective view illustrating a configuration of a prize acquisition game device 1 according to one or more embodiments.

FIG. 3 is a block diagram illustrating a configuration of a prize acquisition game device 1 according to one or more embodiments.

FIG. 4 is a schematic diagram illustrating a configuration of a moving unit (or crane driver) 50 according to one or more embodiments.

FIG. 5 is a schematic diagram illustrating a configuration of an acquisition unit (or crane) 20 according to one or more embodiments.

FIG. 6 is a schematic perspective view illustrating a configuration of a display section 60 according to one or more embodiments.

FIG. 7 is a plan view illustrating a configuration of the display section 60 according to one or more embodiments.

FIG. 8A is a perspective view illustrating a configuration of a second prize placement plate 63 according to one or more embodiments.

FIG. 8B is a plan view illustrating the configuration of the second prize placement plate 63.

FIG. 9 is a schematic perspective view illustrating a first configuration example of the display section 60 in which the second prize placement plate 63 is disposed diagonally.

FIG. 10 is a plan view illustrating a first configuration example of the display section 60 in which the second prize placement plate 63 is disposed diagonally.

FIG. 11 is a schematic perspective view illustrating a second configuration example of the display section 60 in which the second prize placement plate 63 is disposed diagonally.

FIG. 12 is a plan view illustrating a second configuration example of the display section 60 in which the second prize placement plate 63 is disposed diagonally.

FIG. 13 is a schematic perspective view illustrating a configuration example of the display section 60 in which the second prize placement plate 63 is stored and disposed.

FIG. 14 is a plan view illustrating a configuration example of the display section 60 in which the second prize placement plate 63 is stored and disposed.

FIG. 15A is a perspective view illustrating the modified example of the second prize placement plate 63.

FIG. 15B is a plan view illustrating a modified example of the second prize placement plate 63.

FIG. 16 is an explanatory diagram illustrating a display section 60 in which a second prize placement plate 63 not having a shielding portion is disposed diagonally.

FIG. 17 is an explanatory diagram illustrating a second prize placement plate 63 configured so that a shielding portion 63a is detachable.

FIG. 18 is a schematic diagram illustrating a second prize placement plate 63 with a mark M.

FIG. 19 is a schematic perspective view illustrating a modified example of the third support portion 61c.

### DETAILED DESCRIPTION OF EMBODIMENTS

At least the following will become apparent from the description of this specification and the accompanying drawings.

That is, a prize acquisition game device comprises: a crane configured to acquire a prize; a housing having a housing space in which the prize is disposed on an exhibition part, wherein the exhibition part comprises: a first prize placement plate that defines an opening area in the housing space; and a second prize placement plate that covers a portion of the opening area and defines a drop port area in which the prize may drop; and a support that supports the second prize placement plate to be switchable between a straight arrangement and a diagonal arrangement with respect to the first prize placement plate, wherein in the straight arrangement, the second prize placement is shifted from the first prize placement in an orthogonal direction orthogonal to a front-back direction or a left-right direction of the housing, and in the diagonal arrangement, the second prize placement is shifted from the first prize placement in a diagonal direction intersecting the front-back direction or the left-right direction.

According to such a prize acquisition game device, the diagonal arrangement of the second prize placement plate with respect to the first prize placement plate becomes possible.

Furthermore, such a prize acquisition game device may be configured such that:
the second prize placement plate has a multi-sided shape surrounded by at least five straight line portions,
the at least five straight line portions include a first straight line portion and a second straight line portion that are parallel to each other, a third straight line portion that is orthogonal to each of the first straight line portion and the second straight line portion, a fourth straight line portion that is parallel to the third straight line portion, and a fifth straight line portion opposing a vertex where the first straight line portion and the third straight line portion intersect, and
the support supports the vertex and the fifth straight line portion such that the second prize placement plate is shifted in the diagonal direction.

According to such a prize acquisition game device, it is possible to improve the stability of the diagonal arrangement of the second prize placement plate with respect to the first prize placement plate by supporting one as a straight line portion without supporting both as vertexes.

Further, for such a prize acquisition game device,
a length of the first straight line portion and a length of a perpendicular line lowered from the vertex to the fifth straight line portion may be equal.

According to this type of prize acquisition game device, even though it has a compact shape, it is possible to realize rearrangement of the second prize placement plate to a diagonal arrangement.

Furthermore, for such a prize acquisition game device, in the diagonal arrangement, the support may support the vertex and the fifth straight line portion, and support a placement surface of the second prize placement plate from below.

According to such a prize acquisition game device, it is possible to further improve the stability of the diagonal arrangement of the second prize placement plate relative to the first prize placement plate.

Furthermore, in such a prize acquisition game device, the second prize placement plate may have a mark indicating a front side of the front-back direction in the diagonal arrangement.

According to this type of prize acquisition game device, a service provider (for example, a store clerk or the like) can easily position the second prize placement plate diagonally relative to the first prize placement plate by looking at the mark.

Furthermore, for such a prize acquisition game device, the second prize placement plate may be configured such that the prize can be placed on either a front face or a rear face of the second prize placement plate.

According to such a prize acquisition game device, it is possible to increase the variety of diagonal arrangements of the second prize placement plate relative to the first prize placement plate.

Furthermore, in such a prize acquisition game device, the second prize placement plate may comprise a shielding portion that prevents the second prize placement from defining a gap area other than the drop port area in the diagonal arrangement.

According to this type of prize acquisition game device, the shielding portion hides the gap area other than the drop port area, making it easier to place a prize on the second prize placement plate.

Furthermore, for a prize acquisition game device the second prize placement plate may be configured such that the shielding portion is detachable.

According to such a prize acquisition game device, a shielding portion can be used according to the situation of diagonal arrangement of the second prize placement plate with respect to the first prize placement plate.

### Embodiments

### Configuration of Prize Acquisition Game Device 1

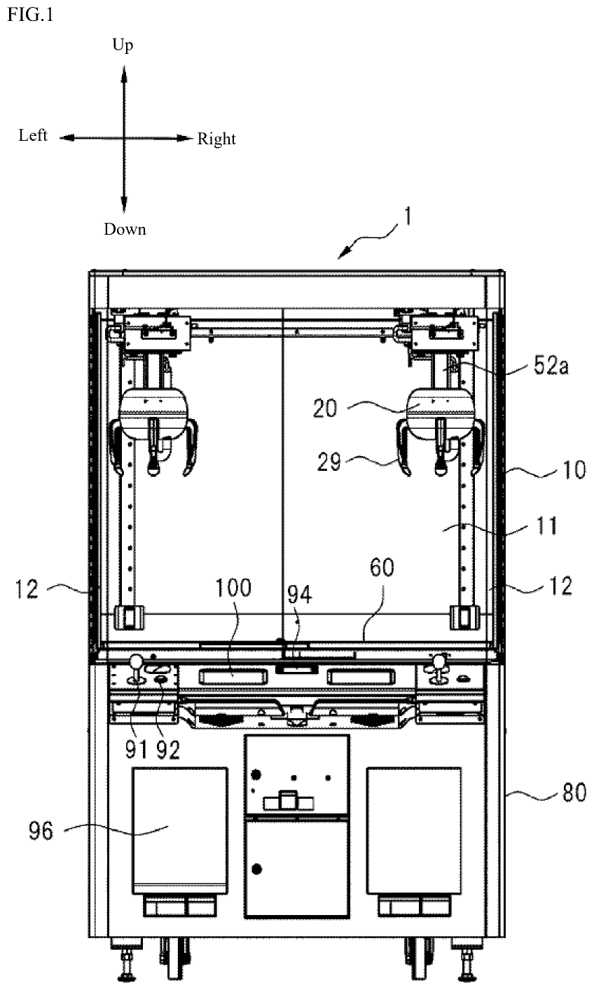

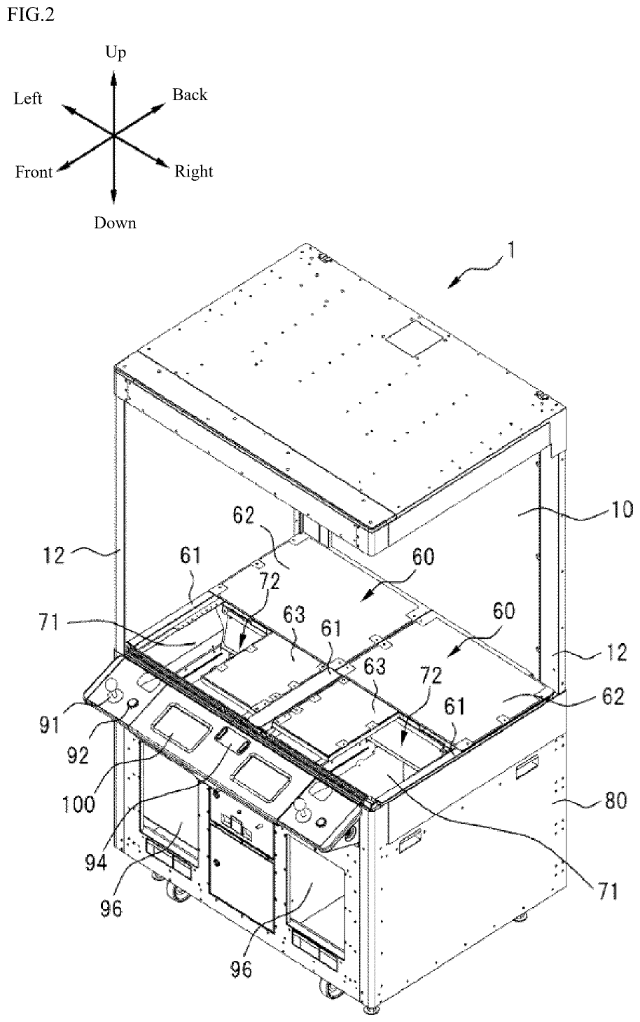

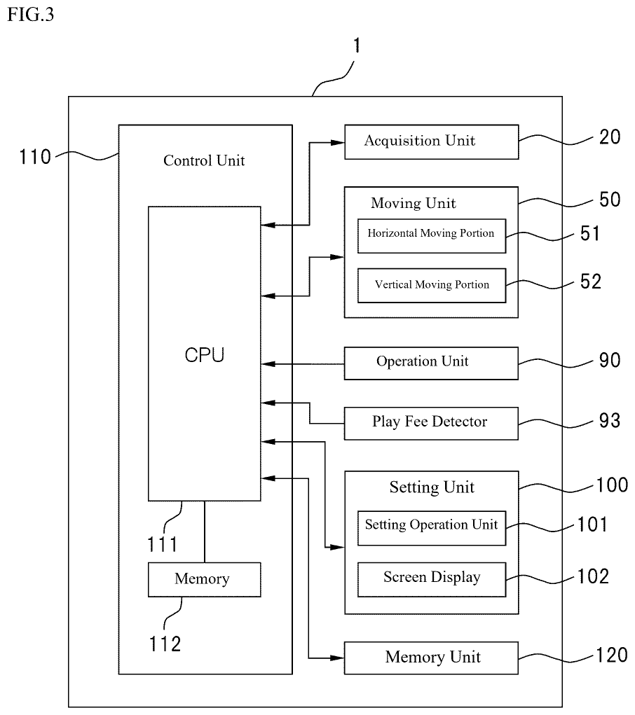

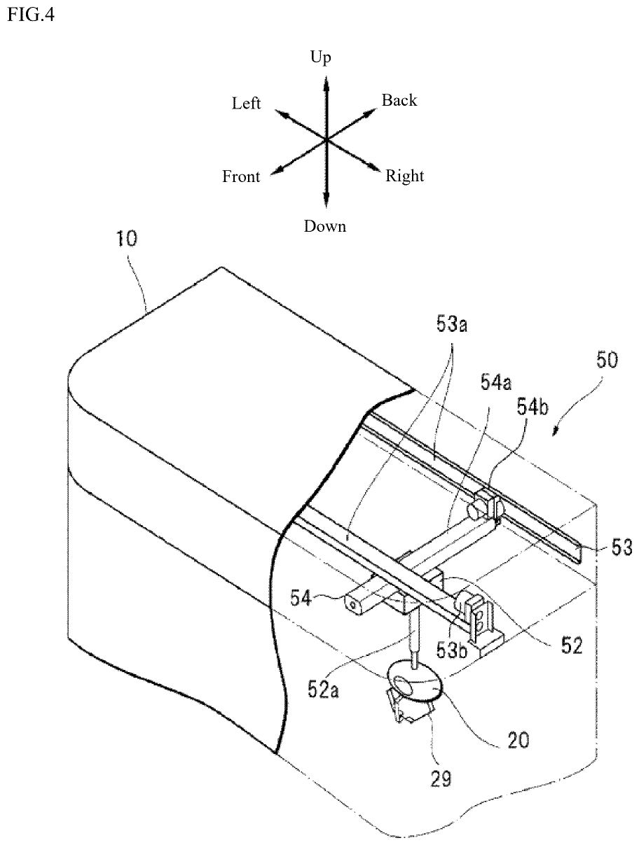

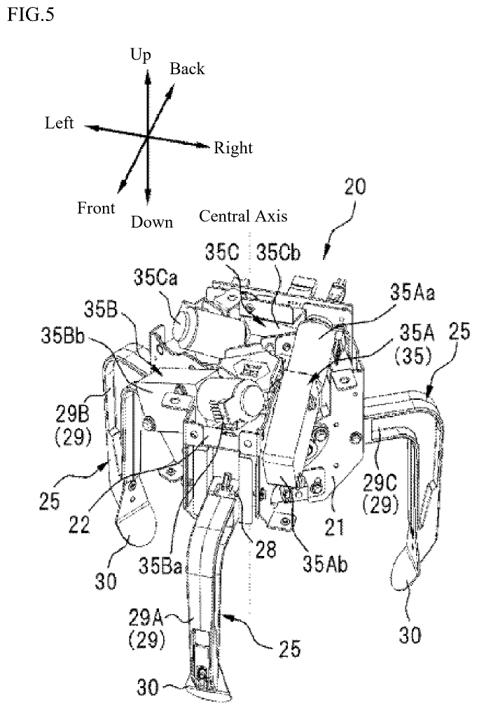

An example of the configuration of the prize acquisition game device 1 according to one or more embodiments will be described using FIG. 1 to FIG. 5. FIG. 1 is an external view illustrating a configuration of a prize acquisition game device 1 according to one or more embodiments. FIG. 2 is a schematic perspective view illustrating a configuration of a prize acquisition game device 1 according to one or more embodiments. Note that FIG. 2 illustrates a state in which the opening and closing door 11, a part of the pillar portion 12, an acquisition unit (or crane) 20, and the like illustrated in FIG. 1, have been removed. FIG. 3 is a block diagram illustrating a configuration of a prize acquisition game device 1 according to one or more embodiments. FIG. 4 is a schematic diagram illustrating a configuration of a moving unit (or crane driver) 50 according to one or more embodiments. FIG. 5 is a schematic diagram illustrating a configuration of the acquisition unit 20 according to one or more embodiments. Note that, in addition, FIG. 5 illustrates a state where the design cover of the acquisition unit 20 is removed.

In the following description, each direction is defined as illustrated in each figure. That is, the vertical direction is defined as the “up-down direction,” and “up” and “down” are defined according to gravity. In addition, the front-back directions are defined as the “front” being the front side and the “back” being the back side from the perspective of a player playing the game facing the prize acquisition game device 1. Additionally, the direction perpendicular to the up-down and front-back directions is defined as the “left-right direction,” and “right” and “left” are defined based on the view from the player's side.

The prize acquisition game device 1 of one or more embodiments is used when a player plays a prize acquisition game, and is equipped with a housing portion (or housing) 10 that stores one or more prizes, and a base portion (or base) 80 disposed below the housing portion 10.

As illustrated in FIG. 1, the housing portion 10 is formed of transparent members (for example, transparent resin, glass, or the like) on the front surface and the left-right sides so that the prize housed within the housing space can be seen by the player. An opening and closing door 11 is disposed on the front of the housing portion 10, allowing a service provider (for example, a store clerk or the like) to display and replenish the prizes. The housing portion 10 has pillar portions 12 disposed at its four corners.

The housing space enclosed by the housing portion 10 is used as a play field where a player plays the prize acquisition game. If the pillar portions 12 on both sides of the opening and closing door 11 are made of a mirror-like material or a transparent material, they will not stand out visually, making the play field look wider.

As illustrated in FIG. 1, FIG. 2, and FIG. 4, the housing portion 10 in one or more embodiments has an acquisition unit 20 that performs the operation of acquiring or catching prizes in the housing space, the moving unit 50 that moves the acquisition unit 20 in the housing space, and a display section 60 (or exhibition part) for displaying/exhibiting the prizes in the housing space.

In one or more embodiments, as illustrated in FIG. 1 and FIG. 2, the acquisition unit 20 and the display section 60 are respectively disposed corresponding to each play area in which the playfield is divided horizontally. Therefore, within each play area, each acquisition unit 20 is configured to move and be able to acquire prizes displayed in each display section 60.

The acquisition unit 20 is for acquiring the prizes contained in the housing portion 10 (the prizes displayed in the display section 60) by opening and closing the arm. As illustrated in FIG. 1 and FIG. 4, the acquisition unit 20 in one or more embodiments is configured so as to be able to grasp a prize by means of three arms, and is connected to the lower end of the lifting member 52a.

As illustrated in FIG. 5, the acquisition unit 20 in one or more embodiments has a base portion 21 connected to the lower end of the lifting member 52a, a plurality of arm portions 25 that perform opening and closing operations, and an arm driver 35 that drives the arm portions 25 to open and close.

The base portion 21 has trifurcated protruding portions 22 that are offset in three directions at 120 degree intervals from a central axis along the vertical direction.

The arm portion 25 has an arm 29 bent into an L shape, an arm connector 28 that detachably connects arm 29 to the base portion 21, and a claw 30 that is detachably attached to the tip of the arm 29.

The arm 29 is made up of three arms, a first arm 29A, a second arm 29B, and a third arm 29C, which extend in a trifurcated shape shifted at 120 degree intervals in three directions around the central axis of the base portion 21 so as to match the trifurcated shape of the protruding portion 22.

The arm driver 35 includes three parts, a first arm driver 35A, a second arm driver 35B, and a third arm driver 35C, one for each arm. As illustrated in FIG. 5, the first arm driver 35A, the second arm driver 35B, and the third arm driver 35C correspond to the first arm 29A, the second arm 29B, and the third arm 29C, respectively, and drive them to open and close separately.

The first arm driver 35A has an arm opening and closing motor 35Aa, and a gearbox 35Ab connected to the arm opening and closing motor 35Aa. The gearbox 35Ab reduces the rotational force of the arm opening and closing motor 35Aa and outputs it.

Similarly, the second arm driver 35B has an arm opening and closing motor 35Ba and a gearbox 35Bb connected to the arm opening and closing motor 35Ba, and the third arm driver 35C has an arm opening and closing motor 35Ca and a gearbox 35Cb connected to the arm opening and closing motor 35Ca.

In the acquisition unit 20 according to one or more embodiments, for example, when the first arm 29A is in an open state, when the arm opening and closing motor 35Aa rotates the output shaft in a predetermined direction, power is transmitted to the first arm 29A via the gearbox 35Ab, and the first arm 29A rotates in a closing direction. At this time, the second arm 29B and the third arm 29C are also rotated in the closing direction in the same manner by the driving of the arm opening and closing motor 35Ba and the arm opening and closing motor 35Ca, respectively.

The moving unit 50 moves the acquisition unit 20 within the play field formed by the housing portion 10. As illustrated in FIG. 3, the moving unit 50 in one or more embodiments has a horizontal moving portion (or horizontal crane driver) 51 and a vertical moving portion (or vertical crane driver) 52.

The horizontal moving portion 51 moves the acquisition unit 20 horizontally (that is, front-back and left-right) on the play field. As illustrated in FIG. 4, the horizontal moving portion 51 in one or more embodiments has a left-right moving portion (left-right crane driver) 53 and a front-back moving portion (front-back crane driver) 54.

The left-right moving portion 53 moves the acquisition unit 20 left and right on the play field.

As illustrated in FIG. 4, the left-right moving portion 53 in one or more embodiments has a pair of fixed rails 53a extending in the left-right direction, a left-right moving motor 53b, an encoder that is not illustrated, and a limit sensor that is not illustrated.

The pair of fixed rails 53a are fixed to the upper portion of the housing portion 10 so as to be parallel to each other along the left-right direction. A front-back moving portion 54 is attached to the pair of fixed rails 53a so as to be slidable in the left-right direction. By driving the left-right moving motor 53b, the front-back moving portion 54 can be moved left-right along the fixed rail 53a.

The encoder detects the number of rotations of the left-right moving motor 53b. Based on the output of this encoder, the position of the front-back moving portion 54 in the left-right direction (in other words, the position of the acquisition unit 20 in the left-right direction) can be detected.

The limit sensor is for detecting when the front-back moving portions 54 reach a limit position in the left-right direction (that is, when the acquisition unit 20 reaches a limit position in the left-right direction).

The front-back moving portions 54 move the acquisition unit 20 in the front-back direction in the playfield.

As illustrated in FIG. 4, the front-back moving portions 54 in one or more embodiments include a movable rail 54a extending along the front-back directions, a front-back moving motor 54b, an encoder that is not illustrated, and a limit sensor that is not illustrated.

A vertical moving portion 52 is attached to the movable rail 54a so as to be slidable along the front-back direction. The vertical moving portion 52 can be moved in the front-back direction along the movable rail 54a by driving the front-back moving motor 54b.

The encoder detects the number of rotations of the front-back moving motor 54b. The position of the vertical moving portion 52 in the front-back direction (that is, the position of the acquisition unit 20 in the front-back direction) can be detected based on the output of this encoder.

The limit sensor is for detecting when the vertical moving portion 52 reaches a limit position in the front-back direction (that is, when the acquisition unit 20 reaches a limit position in the front-back direction).

The vertical moving portion 52 moves the acquisition unit 20 in the vertical direction (that is, the up-down direction) on the play field.

As illustrated in FIG. 4, the vertical moving portion 52 in one or more embodiments has a lifting member 52a that is configured to be freely expandable and contractable in the up-down direction, a wire winding unit that is not illustrated, a vertical moving motor that is not illustrated, an upper limit sensor that is not illustrated, and a lower limit sensor that is not illustrated.

The lifting member 52a is configured by fitting a plurality of pipes of successively smaller diameters in a telescopic manner so as to be freely slidable. The acquisition unit 20 is attached to the lower end of the lifting member 52a in a state where it is connected to a wire that passes through the inside of the pipe.

The wire winding unit is driven by a vertical moving motor to wind up the wire, thereby raising the acquisition unit 20 while sequentially storing the lower pipes in the upper pipe, or to unwind the wire, thereby lowering the acquisition unit 20 while sequentially sending out the lower pipes from the upper pipe.

The upper limit sensor detects whether or not the rising of the acquisition unit 20 has stopped by winding up the wire connected to the acquisition unit 20.

The lower limit sensor detects whether the lowering of the acquisition unit 20 has stopped based on the change in the tension of the wire connected to the acquisition unit 20.

The display section 60 is for displaying the prizes in the housing portion 10, and forms the bottom surface of the play field as illustrated in FIG. 1 and FIG. 2. The display section 60 in one or more embodiments is configured so that prizes can be placed on the prize placement plates 62, 63 for display. On the other hand, the area where the prize placement plates 62, 63 are not disposed becomes a drop port area 72 through which the prizes can be dropped.

When the prize that is acquired and then dropped by the acquisition unit 20 passes (drops) through the drop port area 72 of the display section 60, it is considered to have moved from the play field to the base portion 80. The prize dropped from the drop port area 72 of the display section 60 is detected by an optical sensor and then guided to the prize outlet 96 via a guide path. The optical sensor detects the presence or absence of a prize by using a light-emitting element and a light-receiving element that are installed on the guide path.

The base portion 80 is a base portion of a housing disposed below the housing portion 10, and holds the housing portion 10 at a high position so that a player can play a game while facing the front in a standing position.

As illustrated in FIG. 1 to FIG. 3, the base portion 80 in one or more embodiments has an operation unit (or input device/interface) 90, a play fee detector 93, a prize outlet 96, a setting unit 100 (or I/O interface), a control unit 110 (or controller), and a memory unit (or memory) 120.

The operation unit 90 allows the player to operate the game. As illustrated in FIG. 1 and FIG. 2, the operation unit 90 in one or more embodiments has at least a joystick 91 and an operation button 92.

The joystick 91 is an operating lever that is used by the player to move the acquisition unit 20 in the horizontal direction. The operation button 92 is an operation button used by the player to determine the position of the acquisition unit 20 in the horizontal direction. When the operation button 92 is pressed by the player, the acquisition unit 20 starts to descend at the determined position.

The play fee detector 93 detects the payment of a play fee by a player. The play fee detector 93 in one or more embodiments has a coin slot 94, a coin detection sensor that is not illustrated, a coin passage path that is not illustrated, and a coin box that is not illustrated.

In one or more embodiments, the prize acquisition game is started when a player inserts a predetermined number of coins into the coin slot 94. A coin inserted through the coin slot 94 is detected by a coin detection sensor.

The coin detection sensor is, for example, an optical sensor, and detects the presence or absence of a coin inserted through the coin slot 94 by a light-emitting portion and a light-receiving portion attached on the coin passage. Coins that have passed through the coin currency path in this manner are stored in the coin box.

The prize outlet 96 is disposed on the front surface of the base portion 80 and is for removing a prize that has fallen when the prize acquired by the acquisition unit 20 falls through the opening area in the display section 60.

The setting unit 100 is used when a player performs game operations or the like, or when a service provider performs setting operations. As illustrated in FIG. 1 to FIG. 3, the setting unit 100 in one or more embodiments has a setting operation unit 101 and a screen display 102.

The setting operation unit 101 is for receiving operation input. The setting operation unit 101 in one or more embodiments is configured by a touch panel, and receives input instructions from the operator from the pressing position thereof.

The touch panel is layered on top of the screen display 102, and when a touch operation is performed on the screen, the pressed position (contact position) can be detected based on the change in electrostatic capacitance between the fingertip and the conductive film.

The screen display 102 displays various screens such as a game screen and a setting screen. The screen display 102 in one or more embodiments is configured with a liquid crystal display.

The control unit 110 is disposed inside the base portion 80 and is a control unit for carrying out various controls of the prize acquisition game device 1. As illustrated in FIG. 3, the control unit 110 includes at least a central processing unit (CPU) 111 and a memory 112.

The CPU 111 is an arithmetic processing device for controlling the entire game device. The memory 112 is used to secure an area for storing programs or instructions for the CPU 111, a working area, and the like, and includes a storage element such as a random access memory (RAM).

The memory unit 120 is a unit that stores programs or instructions and data for the control unit 110 to execute game processing. In one or more embodiments, a memory element such as a read only memory (ROM) which is a read-only memory area is provided.

### Configuration of Display Section 60

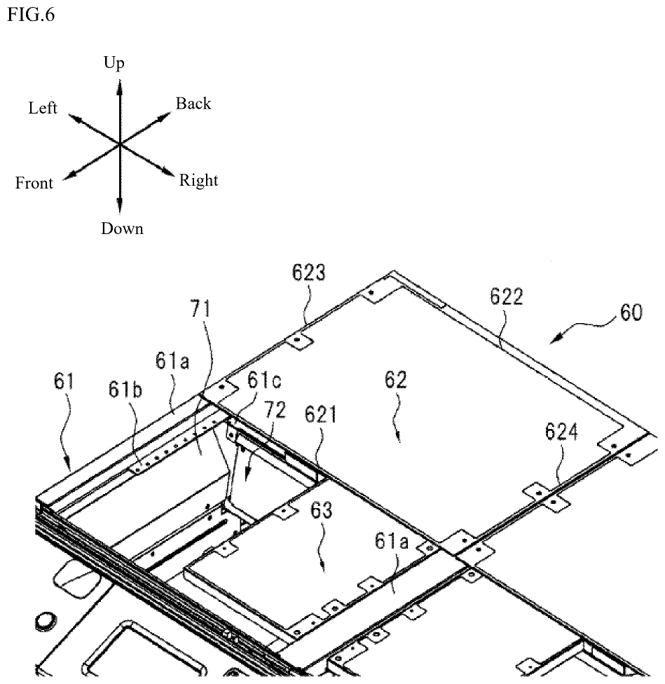

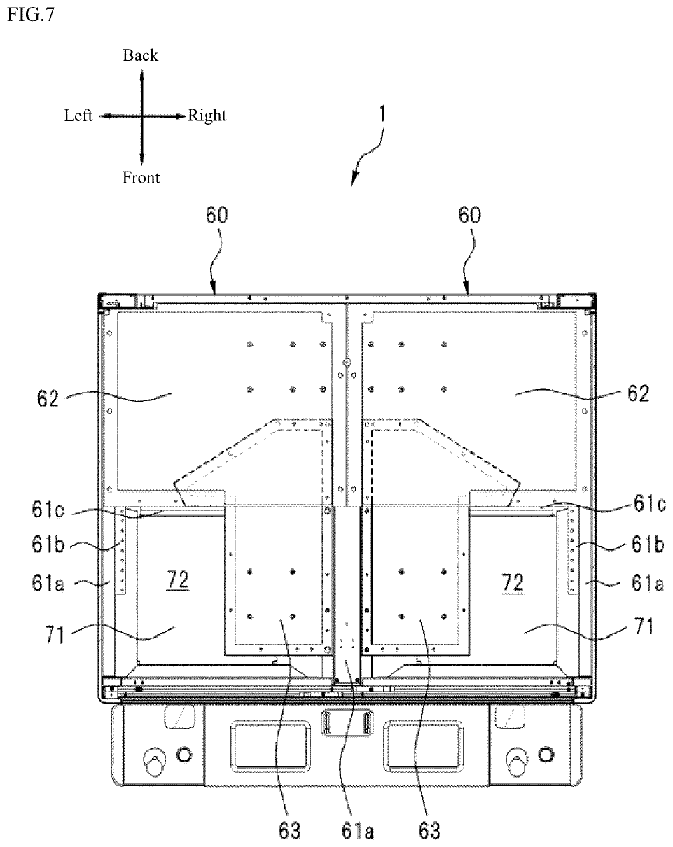

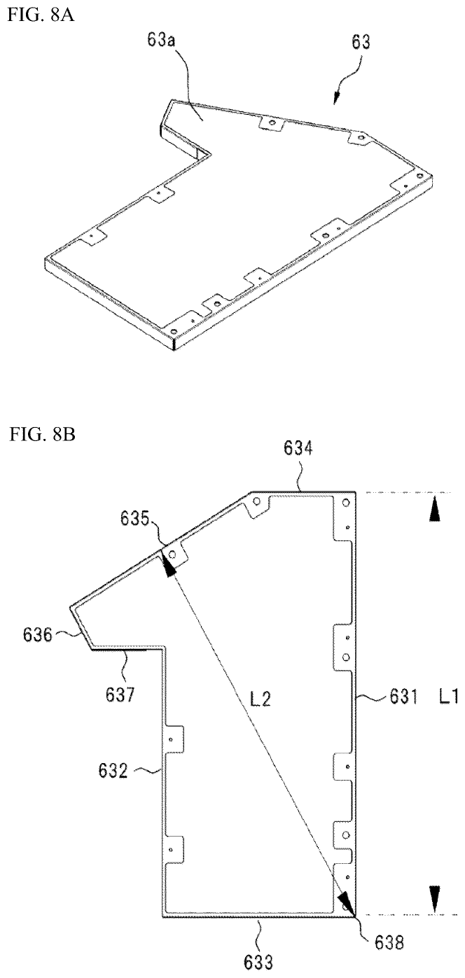

An example of the configuration of the display section 60 according to one or more embodiments will be described with reference to FIG. 2 and FIG. 6 to FIG. 8B. FIG. 6 is a schematic perspective view illustrating a configuration of a display section 60 according to one or more embodiments. FIG. 7 is a plan view illustrating a configuration of the display section 60 according to one or more embodiments. FIG. 8A is a perspective view illustrating a configuration of the second prize placement plate 63. FIG. 8B is a plan view illustrating the configuration of the second prize placement plate 63. Below, all of the left-right play areas in the playfield (housing space) have

largely the same structure, and thus a display section 60 (see FIG. 6) disposed mainly in the left play area will be specifically described.

The display section 60 according to one or more embodiments is displayed by placing the prize in a housing space, and, as illustrated in FIG. 2 and FIG. 6, has a support portion (or support) 61, a first prize placement plate 62 that forms an opening area 71 by being disposed in the housing space, and a second prize placement plate 63 that forms a drop port area 72 that closes a portion of the opening area 71 and causes the prize to drop.

The support portion 61 supports the first prize placement plate 62 and the second prize placement plate 63 so that they can be positioned in the housing space, and has a first support portion (or first support) 61a, a second support portion (or second support) 61b, and a third support portion (or third support) 61c, as illustrated in FIG. 6 and FIG. 7.

The first support portion 61a is configured using a frame member (of frame) extending at least in the front-back direction, and supports both the left-right ends of the first prize placement plate 62 from below, as illustrated in FIG. 6 and FIG. 7. In one or more embodiments, the first prize placement plate 62 is fixed and supported so that it cannot be redisposed within the housing space.

As illustrated in FIG. 6 and FIG. 7, the second support portion 61b is attached to the first support portion 61a along the front-back direction and is configured using a pair of rail members whose cross section is bent into a crank shape. The second support portion 61b in one or more embodiments supports the second prize placement plate 63 from below by one or both of a pair of rail members so that the second prize placement plate 63 can be redisposed within the housing space. Note that the second support portion 61b may be configured using a slit-shaped rail member, and may support the second prize placement plate 63 by being sandwiched in the slit.

In FIG. 6 and FIG. 7, one side of the rail member supports the second prize placement plate 63, and also supports the portion of the second prize placement plate 63 illustrated by the dashed line in FIG. 7 so as to be hidden under the first prize placement plate 62.

In other words, in one or more embodiments, a housing space is formed below the first prize placement plate 62 supported by the first support portion 61a in which the second prize placement plate 63 supported by the second support portion 61b can be stored while hiding at least a portion of it.

In addition, the second support portion 61b in one or more embodiments supports the second prize placement plate 63 below the first prize placement plate 62 in a slidable state. Therefore, by sliding the second prize placement plate 63 in the front-back direction, the second prize placement plate 63 can be redisposed with respect to the first prize placement plate 62, and the shape and size of the placement area where the prize can be placed can be changed, or the shape and size of the drop port area 72 can be changed.

In addition, it is preferable that the second prize placement plate 63 supported by the second support portion 61b is locked so that its position does not change. In one or more embodiments, by using a locking member such as a screw, the arrangement of the second prize placement plate 63 relative to the first prize placement plate 62 can be prevented from changing.

For example, the second prize placement plate 63 is secured in place by screwing it into the location where the position of a plurality of through holes disposed in the second prize placement plate 63 coincides with the position of any one of a plurality of screw holes disposed in the second support portion 61b. Note that if the screw holes in the second support portion 61b are disposed at equal intervals, it is possible to set the locking positions in stages at each interval.

The third support portion 61c is disposed between the pair of rail members used by the second support portion 61b and provides auxiliary support for the lower surface of the second prize placement plate 63 supported by the second support portion 61b. As illustrated in FIG. 6 and FIG. 7, the third support portion 61c in one or more embodiments is constructed using a frame member (or frame) extending at least in the left-right direction, and is attached so as to connect a pair of rail members used by the second support portion 61b.

As illustrated in FIG. 6, the first prize placement plate 62 is rectangular and surrounded by long straight line portions (or long straight lines) 621, 622 corresponding to the long sides and short straight line portions (or short straight lines) 623, 624 corresponding to the short sides, and is fixed within the housing space so that its position cannot be changed in principle. The area (unblocked area) within the housing space where the first prize placement plate (fixed prize placement plate) is not disposed is the opening area 71.

Note that, since prizes are placed thereon, it is preferable that the placement surface (upper surface) of the first prize placement plate 62 be a horizontal plane. However, the present invention is not limited to this, and a small step or a slight incline may be provided.

The second prize placement plate 63 is configured to be re-deployable within the housing space, and is supported by the second support portion 61b so as to block a portion of the opening area 71 to form the drop port area 72.

In one or more embodiments, the second prize placement plate 63 is supported by the second support portion 61b in an orthogonal direction orthogonal to the front-back direction or left-right direction relative to the first prize placement plate 62, as illustrated in FIG. 6 and FIG. 7, thereby forming a drop port area 72.

In addition, the second prize placement plate 63 has a polygonal shape and surrounded by at least five straight lines, and the at least five straight lines include a first straight line portion (or first straight line) and a second straight line portion (or second straight line) that are parallel to each other, a third straight line portion (or third straight line) that is perpendicular to each of the first straight line portion and the second straight line portion, a fourth straight line portion (or fourth straight line) that is parallel to the third straight line portion, and a fifth straight line portion (or fifth straight line) that faces the vertex where the first straight line portion and the third straight line portion intersect.

As illustrated in FIG. 8B, the second prize placement plate 63 in one or more embodiments has a polygonal shape surrounded by seven straight line portions (or straight lines), namely, a first straight line portion (or first straight line) 631 and a second straight line portion (or second straight line) 632 which are parallel to each other, a third straight line portion (or third straight line) 633 which is perpendicular to each of the first straight line portion 631 and the second straight line portion 632, a fourth straight line portion (or fourth straight line) 634 which is parallel to the third straight line portion 633, a fifth straight line portion (or fifth straight line) 635 which faces a vertex portion (or vertex) 638 where the first straight line portion 631 and the third straight line portion 633 intersect, a sixth straight line portion (or sixth straight line) 636 which is perpendicular to the fifth straight line portion 635, and a seventh straight line portion (or seventh straight line) 637 which is perpendicular to the second straight line portion 632.

The second prize placement plate 63 is configured so that a prize can be placed upside down. FIG. 2 and FIG. 7 illustrate a case where the second prize placement plate 63 is upside down and used in the display section 60 disposed in the right side play area among the left-right play areas in the playfield (housing space).

Note that the material of the front surface and back surface of the second prize placement plate 63 can be made, for example, slippery or non-slip, thereby changing the degree of difficulty in obtaining the prize. It is also possible to change the design of the display section by changing the colors of the front surface and back surface.

### Diagonal Arrangement of the Second Prize Placement Plate 63

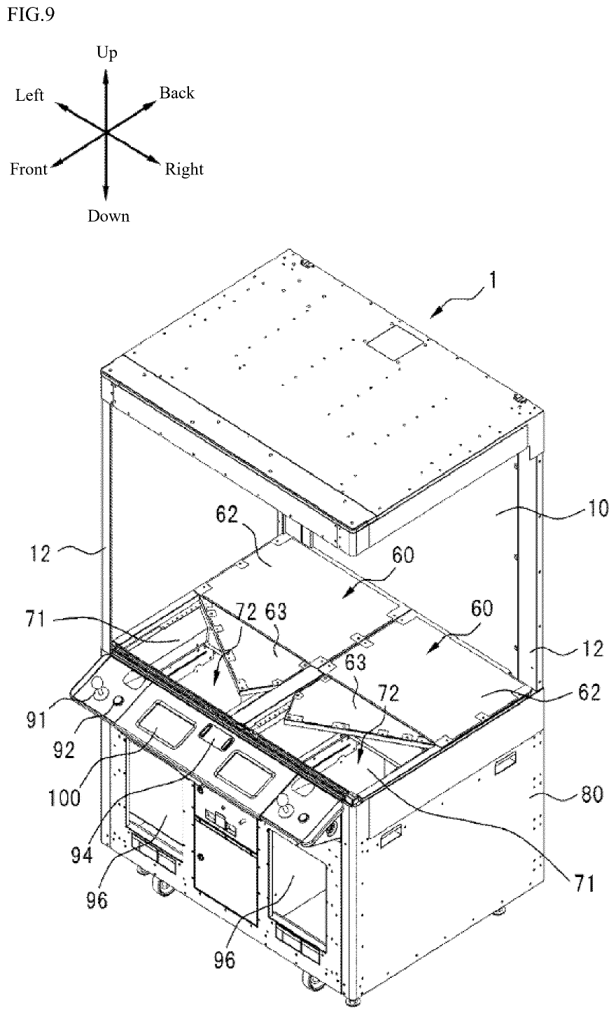

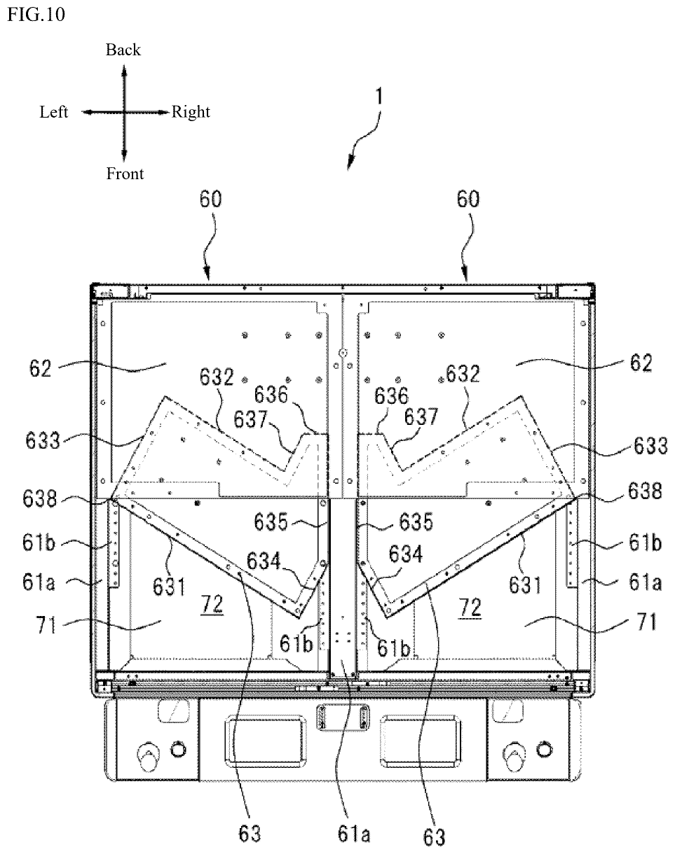

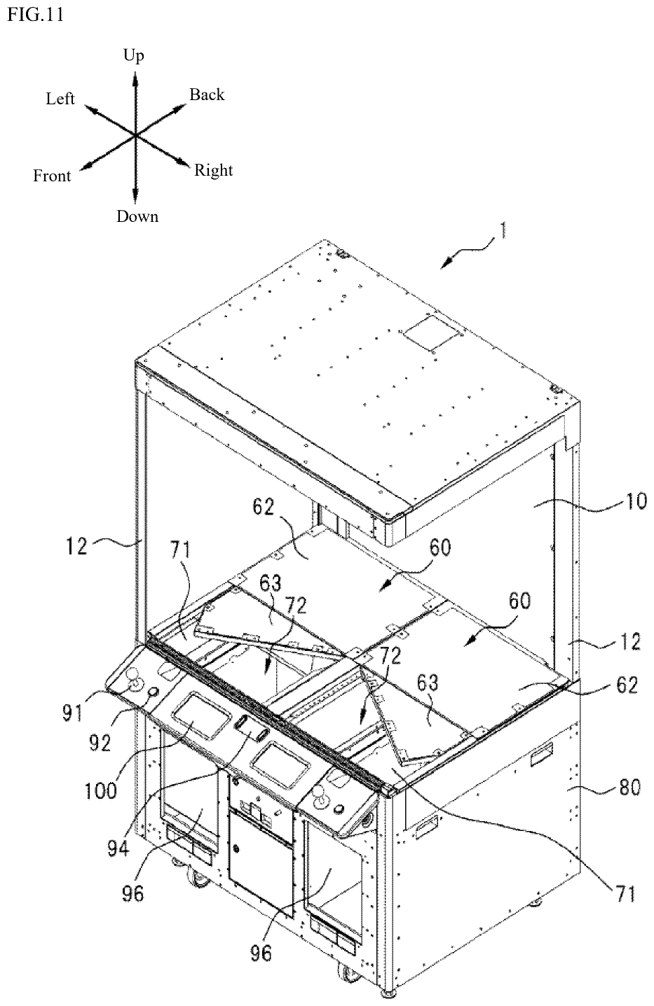

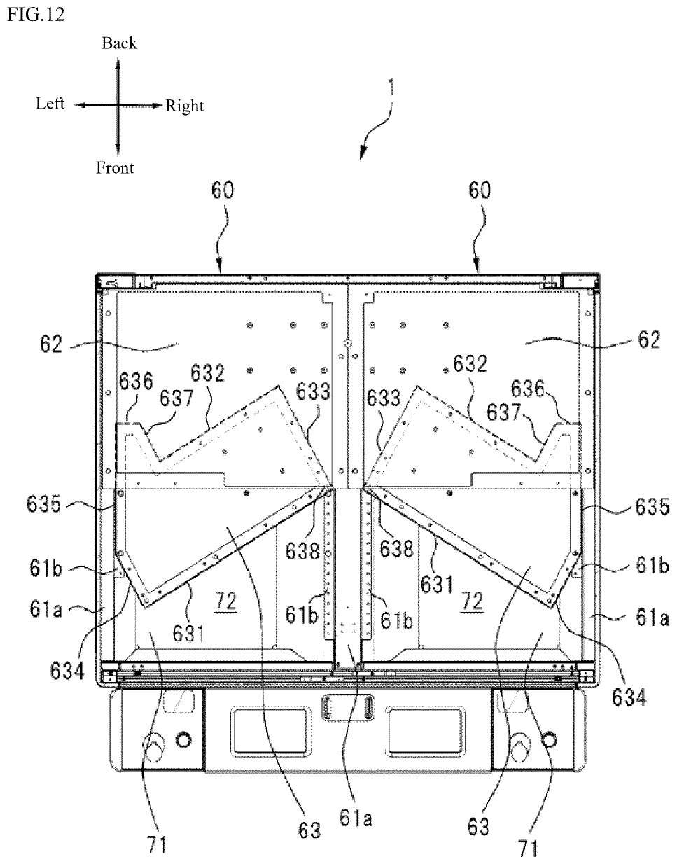

Diagonal arrangement of the second prize placement plate 63 according to one or more embodiments will be described with reference to FIGS. 8A-8B and FIG. 9 to FIG. 12. FIG. 9 is a schematic perspective view illustrating a first configuration example of the display section 60 in which the second prize placement plate 63 is disposed diagonally. FIG. 10 is a plan view illustrating a first configuration example of the display section 60 in which the second prize placement plate 63 is disposed diagonally. FIG. 11 is a schematic perspective view illustrating a second configuration example of the display section 60 in which the second prize placement plate 63 is disposed diagonally. FIG. 12 is a plan view illustrating a second configuration example of the display section 60 in which the second prize placement plate 63 is disposed diagonally.

Note that FIG. 9 and FIG. 11 illustrate a state in which the opening and closing door 11, a portion of the pillar portion 12, the acquisition unit 20, and the like illustrated in FIG. 1, are removed.

Furthermore, FIG. 9 and FIG. 10 illustrate a case where the second prize placement plate 63 illustrated in FIG. 8 is upside down and used in the display section 60 disposed in the right side play area among the left-right play areas in the playfield (housing space).

On the other hand, FIG. 11 and FIG. 12 illustrate a case where the second prize placement plate 63 illustrated in FIGS. 8A-8B is upside down and used in the display section 60 disposed in the left side play area among the left-right play areas in the playfield (housing space).

The second prize placement plate 63 can be redisposed from the basic arrangement illustrated in FIG. 7 to a diagonal arrangement in which it is shifted in a diagonal direction that intersects diagonally with the front-back or left-right direction with respect to the first prize placement plate 62.

As illustrated in FIG. 9 to FIG. 12, the second prize placement plate 63 of one or more embodiments is supported by the second support portion 61b in a diagonal arrangement in a diagonal direction intersecting the front-back direction or the left-right direction with respect to the first prize placement plate 62, thereby forming a drop port area 72. This allows the placement surface (upper surface) of the first prize placement plate 62 to be turned diagonally while maintaining it horizontal, thereby increasing the variety of rearrangements of the second prize placement plate relative to the first prize placement plate.

When the second prize placement plate 63 is positioned diagonally relative to the first prize placement plate 62, the second support portion 61b supports the vertex portion 638 and the fifth straight line portion 635 of the second prize placement plate 63 by a pair of rail members, as illustrated in FIG. 10 and FIG. 12. Furthermore, the third support portion 61c supports from below the placement surface of the second prize placement plate 63 supported by the second support portion 61b (the portion sandwiched from above and below between the first prize placement plate 62 and the third support portion 61c). Then, in FIG. 10 and FIG. 12, the portion of the second prize placement plate 63 indicated by the dashed lines is supported so as to be hidden below the first prize placement plate 62.

In one or more embodiments, the second prize placement plate 63 can be disposed diagonally by being supported only by the second support portion 61b, but the stability of the angled arrangement can be increased by the third support portion 61c providing additional support.

The second support portion 61b in one or more embodiments supports the second prize placement plate 63 below the first prize placement plate 62 in a slidable state. Therefore, by sliding the second prize placement plate 63 in a diagonal manner in the front-back direction, the second prize placement plate 63 can be redisposed with respect to the first prize placement plate 62, and the shape and size of the placement area where the prize can be placed can be changed, or the shape and size of the drop port area 72 can be changed.

### Storage Arrangement of the Second Prize Placement Plate 63

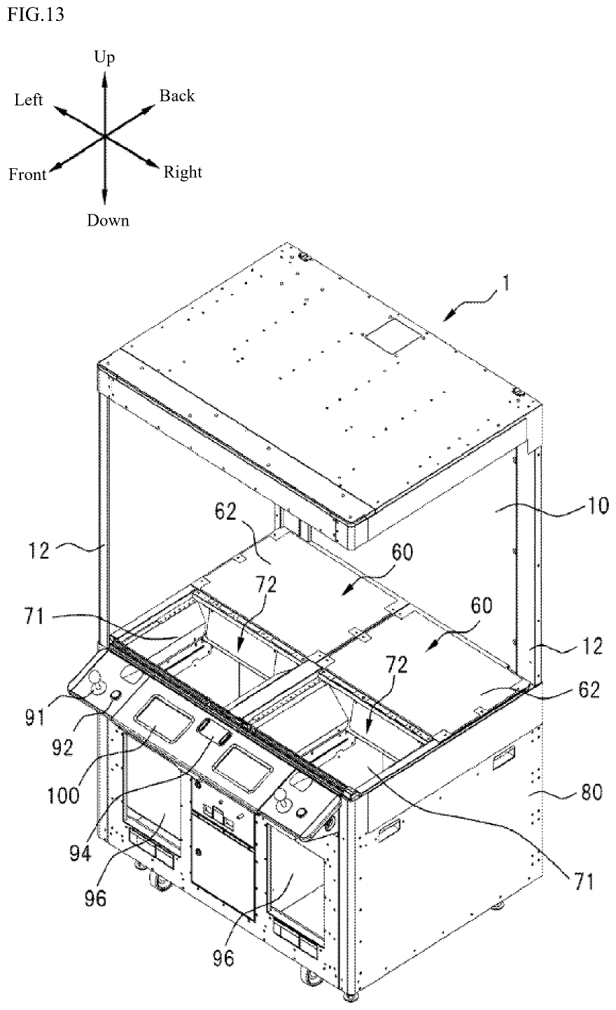

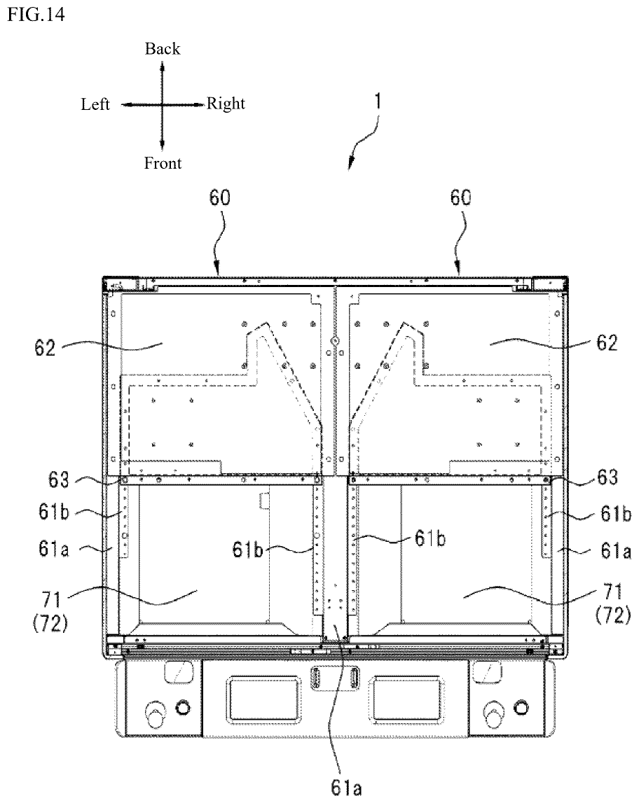

The storage arrangement of the second prize placement plate 63 according to one or more embodiments will be described with reference to FIGS. 8A-8B, FIG. 13, and FIG. 14. FIG. 13 is a schematic perspective view illustrating a configuration example of the display section 60 in which the second prize placement plate 63 is stored and disposed. Note that FIG. 13 illustrates a state in which the opening and closing door 11, a portion of the pillar portion 12, the acquisition unit 20, and the like illustrated in FIG. 1, are removed. FIG. 14 is a plan view illustrating a configuration example of the display section 60 in which the second prize placement plate 63 is stored and disposed.

The second prize placement plate 63 can be redisposed from the basic arrangement illustrated in FIG. 7 or the diagonal arrangement illustrated in FIG. 10 and FIG. 12 to a storage arrangement shifted with respect to the first prize placement plate 62 in a Cartesian direction orthogonal to the front-back direction or the left-right direction.

As illustrated in FIG. 13 and FIG. 14, the second prize placement plate 63 of one or more embodiments is supported by the second support portion 61b in a storage arrangement shifted in a Cartesian direction orthogonal to the front-back direction or the left-right direction with respect to the first prize placement plate 62 (that is, an arrangement in which the second prize placement plate 63 is rotated by 90° from the basic arrangement illustrated in FIG. 7), thereby forming a drop port area 72.

As illustrated in FIG. 14, in this storage arrangement, the second prize placement plate 63 does not cover a part of the opening area 71, so a drop port area 72 of the same size as the opening area 71 is formed.

When the second prize placement plate 63 is in the storage arrangement relative to the first prize placement plate 62, the second support portion 61b supports the third straight line portion 633 and the fourth straight line portion 634 of the second prize placement plate 63 by a pair of rail members, as illustrated in FIG. 13 and FIG. 14. Furthermore, the third support portion 61c supports from below the placement surface of the second prize placement plate 63 supported by the second support portion 61b. Then, in FIG. 14, the portion of the second prize placement plate 63 indicated by the dashed lines is supported so as to be hidden below the first prize placement plate 62.

The second support portion 61b in one or more embodiments supports the second prize placement plate 63 below the first prize placement plate 62 in a slidable state. Therefore, by sliding the second prize placement plate 63 toward the front side in the front-back directions while in the storage arrangement, the second prize placement plate 63 can be redisposed with respect to the first prize placement plate 62, and the shape and size of the placement area where the prize can be placed can be changed, or the shape and size of the drop port area 72 can be changed.

Furthermore, the second prize placement plate 63 in one or more embodiments is formed so that the length L1 of the first straight line portion 631 and the length L2 of the perpendicular line dropping from the vertex portion 638 to the fifth straight line portion 635 are equal, as illustrated in FIG. 8B. Therefore, even if the first prize placement plate 62 is redisposed to the diagonal arrangement illustrated in FIG. 10 and FIG. 12, or to the storage arrangement illustrated in FIG. 14, it can be compactly stored between a pair of rail members disposed on the second support portion 61b.

### Other Embodiments

The above embodiments are provided to facilitate understanding of the present invention, and are not to be construed as limiting the present invention. The present invention can be modified or improved without departing from the spirit thereof, and the present invention also includes equivalents thereof. In particular, the embodiments described below are also included in the present invention. In other words, the present invention can be configured by appropriately combining the above embodiments with the embodiments described below.

Furthermore, it is also possible to construct various inventions by appropriately combining multiple invention-specific features disclosed in the above embodiments. For example, the invention may be constructed by deleting some of the invention-specific matters from all of the invention-specific matters disclosed in the above embodiments, or the invention may be constructed by appropriately combining all of the invention-specific matters disclosed in the above embodiments with the invention-specific matters disclosed in the embodiments described below.

### Prizes

In the above embodiments, the prizes stored in the housing portion 10 are not limited to items that the player can directly acquire (for example, stuffed toys or the like), but also include items that are stored as targets for acquisition in the game and can be exchanged for other prizes after acquisition, and items that are not provided themselves but are used to compete for points or rankings.

### Arm

In the above embodiments, the acquisition unit 20 having three arm portions 25 has been described as an example, but the present invention is not limited to this. For example, the present invention can also be applied to an acquisition unit 20 having two or less arm portions 25 and an acquisition unit 20 having four or more arm portions 25.

### Polylateral Shape of Second Prize Placement Plate

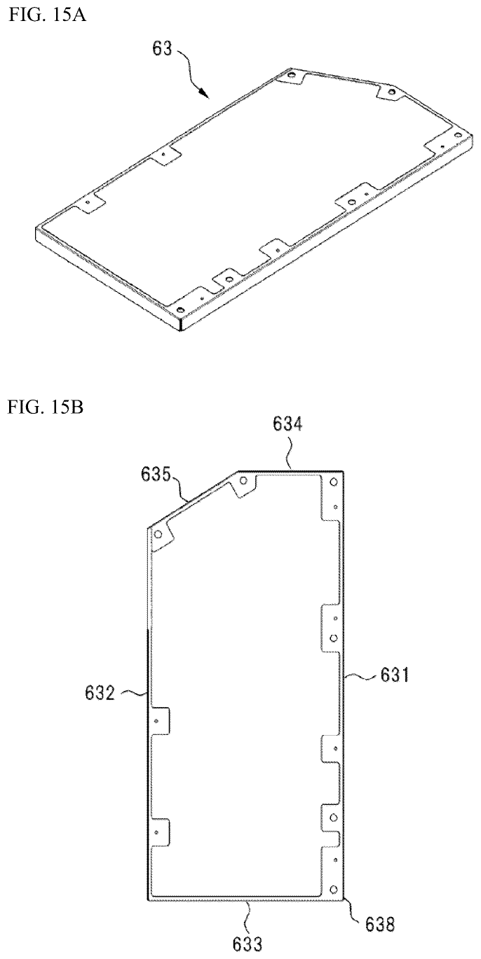

In the above embodiments, the second prize placement plate 63 (see FIGS. 8A-8B) is described as an example having a polygonal shape surrounded by seven straight line portions. However, the present invention is not limited to this, and may have a polygonal shape surrounded by at least five straight line portions. A modified example of the second prize placement plate 63 will be described below using FIGS. 15A-15B. FIG. 15A is a perspective view illustrating a modified example of the second prize placement plate 63. FIG. 15B is a plan view illustrating a modified example of the second prize placement plate 63.

For example, as illustrated in FIGS. 15A-15B, the second prize placement plate 63 may be a polygonal shape surrounded by five straight line portions, that is, a first straight line portion 631 and a second straight line portion 632 that are parallel to each other, a third straight line portion 633 that is perpendicular to the first straight line portion 631 and the second straight line portion 632, a fourth straight line portion 634 that is parallel to the third straight line portion 633, and a fifth straight line portion 635 that is opposed to a vertex portion 638 where the first straight line portion 631 and the third straight line portion 633 intersect.

Even if the second prize placement plate 63 has a polygonal shape as illustrated in FIGS. 15A-15B, the second support portion 61b supports the vertex portion 638 and the fifth straight line portion 635 of the second prize placement plate 63 with a pair of rail members, making it possible to position the second prize placement plate 63 diagonally relative to the first prize placement plate 62.

### Shielding Portion of Second Prize Placement Plate

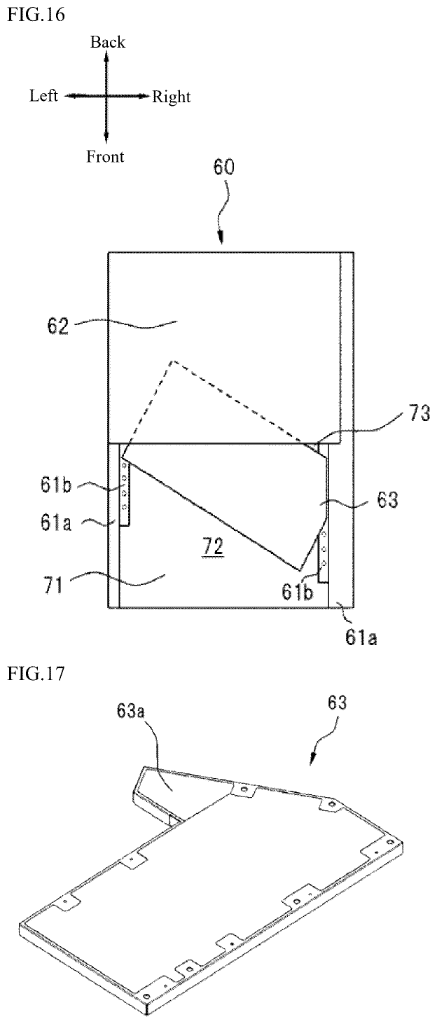

In the above embodiments, as illustrated in FIG. 8A, the second prize placement plate 63 has a shielding portion 63a. The shielding portion 63a of the second prize placement plate 63 will be described below with reference to FIG. 16 and FIG. 17. FIG. 16 is a diagram describing a display section 60 having a second prize placement plate 63 having no shielding portion disposed diagonally. FIG. 17 is a diagram describing a second prize placement plate 63 configured such that the shielding portion 63a is detachable.

As illustrated in FIG. 16, when a second prize placement plate 63 (see FIGS. 15A-15B) that does not have a shielding portion 63a is positioned diagonally relative to the first prize placement plate 62, a gap area 73 other than the drop port area 72 may be formed in the opening area 71. The gap area 73 may hinder the placement of prizes. Therefore, as illustrated in FIG. 8A, by disposing a shielding portion 63a in the second prize placement plate 63, the gap area 73 can be hidden.

As illustrated in FIG. 17, the shielding portion 63a of the second prize placement plate 63 may be a separate part that is detachable from the main body. As a result, the shielding portion 63a can be attached to the second prize placement plate 63 only when a gap area 73 occurs depending on the diagonal arrangement situation.

### Marking of the Second Prize Placement Plate

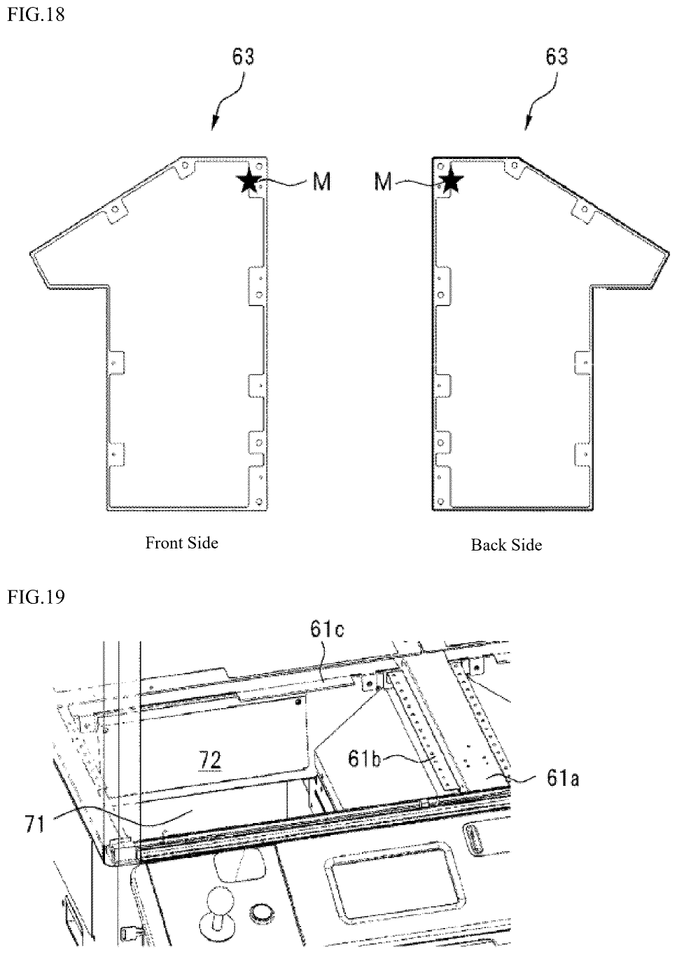

In the above embodiments, a marker indicating a front side in the front-back direction may be attached to the second prize placement plate 63 in order to make it easier to diagonally dispose the second prize placement plate 63. A marker of the second prize placement plate 63 will be described below using FIG. 18. FIG. 18 is a schematic diagram illustrating a second prize placement plate 63 having a mark M attached thereto.

When the second prize placement plate 63 is disposed diagonally, it may be difficult to know in what direction it should be attached to the second support portion 61b. Therefore, as illustrated in FIG. 18, a mark M indicating the front portion of the second prize placement plate 63 in the front-back direction when positioned diagonally is placed on the first straight line portion 631 side of the second prize placement plate 63 (or on the fourth straight line portion 634 side). In addition, this mark M may be placed on both the front side and back side of the second prize placement plate 63. As a result, the service provider (for example, a store clerk or the like) can easily dispose the second prize placement plate 63 diagonally if the mark M of the second prize placement plate 63 is disposed so as to be in the front side of the front-back direction.

### Third Support Portion

In the above embodiments, an example has been described in which the third support portion 61c is attached so as to connect a pair of rail members used by the second support portion 61b, as illustrated in FIG. 6 and FIG. 7. However, this is not limited to this, and it is sufficient that the third support portion 61c provides auxiliary support for the underside of the second prize placement plate 63 supported by the second support portion 61b between the pair of rail members used by the second support portion 61b. Hereinafter, a modified example of the third support portion 61c will be described using FIG. 19. FIG. 19 is a schematic perspective view illustrating a modified example of the third support portion 61c.

For example, as illustrated in FIG. 19, the third support portion 61c may be configured using a portion of a frame member (of frame) extending in the left-right direction that protrudes forward in the front-back direction. This allows the third support portion 61c to provide auxiliary support for the underside of the second prize placement plate 63, thereby increasing stability when the second prize placement plate 63 is in the basic arrangement (see FIG. 7) or diagonally (see FIGS. 10 and 12).

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF REFERENCE NUMERALS

1 Prize acquisition game device, 10 Housing portion, 11 Opening and closing door, 12 Pillar portion, 20 Acquisition unit, 21 Base portion, 22 Protruding portion, 25 Arm portion, 28 Arm connector, 29 Arm, 29A First arm, 29B Second arm, 29C Third arm, 30 Claw, 35 Arm driver, 35A First arm driver, 35Aa Arm opening and closing motor, 35Ab Gearbox, 35B Second drive unit, 35Ba Arm opening and closing motor, 35Bb Gearbox, 35C Third drive unit, 35Ca Arm opening and closing motor, 35Cb Gearbox, 50 Moving unit, 51 Horizontal moving portion, 52 Vertical moving portion, 52a Lifting member, 53 Left-right moving portion, 53a Fixed rail, 53b Left-right moving motor, 54 Front-back moving portion, 54a Movable rail, 54b Front-back moving motor, 60 Display section, 61 Support portion, 61a First support portion, 61b Second support portion, 61c Third support portion, 62 First prize placement plate, 63 Second prize placement plate, 63a Shielding portion, 71 Opening area, 72 Drop port area, 73 Gap area, 80 Base portion, 90 Operation unit, 91 Joystick, 92 Operation button, 93 Play fee detector, 94 Coin slot, 96 Prize outlet, 100 Setting unit, 101 Setting unit, 102 Screen display, 110 Control unit, 111 CPU, 112 Memory, 120 Memory unit, 621 Long straight line portion, 622 Long straight line portion, 623 Short straight line portion, 624 Short straight line portion, 631 First straight line portion, 632 Second straight line portion, 633 Third straight line portion, 634 Fourth straight line portion, 635 Fifth straight line portion, 636 Sixth straight line portion, 637 Seventh straight line portion, 638 Vertex portion

What is claimed is:

1. A prize acquisition game device comprising:
a crane configured to acquire a prize;
a housing having a housing space in which the prize is disposed on an exhibition part, wherein the exhibition part comprises:
a first prize placement plate that defines an opening area in the housing space; and
a second prize placement plate that covers a portion of the opening area and defines a drop port area in which the prize may drop; and
a support that supports the second prize placement plate to be switchable between a straight arrangement and a diagonal arrangement with respect to the first prize placement plate, wherein
in the straight arrangement, the second prize placement is shifted from the first prize placement plate in an orthogonal direction orthogonal to a front-back direction or a left-right direction of the housing, and
in the diagonal arrangement, the second prize placement is shifted from the first prize placement plate in a diagonal direction intersecting the front-back direction or the left-right direction.

2. The prize acquisition game device according to claim 1, wherein
the second prize placement plate has a multi-sided shape surrounded by at least five straight line portions,
the at least five straight line portions include:
a first straight line portion and a second straight line portion that are parallel to each other;
a third straight line portion that is orthogonal to each of the first straight line portion and the second straight line portion;
a fourth straight line portion that is parallel to the third straight line portion; and
a fifth straight line portion opposing a vertex where the first straight line portion and the third straight line portion intersect, and
the support supports the vertex and the fifth straight line portion such that the second prize placement plate is shifted in the diagonal direction.

3. The prize acquisition game device according to claim 2, wherein
a length of the first straight line portion and a length of a perpendicular line lowered from the vertex to the fifth straight line portion are equal.

4. The prize acquisition game device according to claim 2, wherein
in the diagonal arrangement, the support supports the vertex and the fifth straight line portion, and supports a placement surface of the second prize placement plate from below.

5. The prize acquisition game device according to claim 1, wherein
the second prize placement plate has a mark indicating a front side of the front-back direction in the diagonal arrangement.

6. The prize acquisition game device according to claim 1, wherein
the second prize placement plate is configured such that the prize can be placed on either a front face or a rear face of the second prize placement plate.

7. The prize acquisition game device according to claim 1, wherein
the second prize placement plate comprises:
a shielding portion that prevents the second prize placement from defining a gap area other than the drop port area in the diagonal arrangement.

8. The prize acquisition game device according to claim 7. wherein
the second prize placement plate is configured such that the shielding portion is detachable.
